(19) United States
(12) Patent Application Publication
(10) Pub. No.: US 2023/0385496 A1
(43) Pub. Date: Nov. 30, 2023

(54) LOGIC LOCKING OPERATIONS

(71) Applicant: INTERNATIONAL BUSINESS MACHINES CORPORATION, Armonk, NY (US)

(72) Inventors: Jinwook JUNG, Somers, NY (US); Jennifer KAZDA, Englewood, NJ (US); Schuyler ELDRIDGE, Ossining, NY (US); Peilin SONG, Lagrangeville, NY (US); Gi-Joon NAM, Chappqua, NY (US)

(73) Assignee: INTERNATIONAL BUSINESS MACHINES CORPORATION, Armonk, NY (US)

(21) Appl. No.: 17/664,861

(22) Filed: May 24, 2022

(51) Int. Cl. G06F 30/3315; G06F 21/75

(52) U.S. Cl. CPC G06F 30/3315; G06F 21/75; G06F 2117/04

(57) ABSTRACT

Embodiments are provided for providing enhanced protection of an integrated circuit in a computing system by a processor. A logic locking FSM component or a logic locking with RTL gating may be applied to a current design logic to enable and protect operations of an integrated circuit, where the current design logic remains unchanged. The operation of the integrated circuit may be activated based upon providing to the integrated circuit a correct key from the logic locking FSM component or the logic locking with RTL gating.

### BACKGROUND

The present invention relates in general to computing systems, and more particularly, to various embodiments for providing enhanced protection of an integrated circuit using a computing processor.

### SUMMARY

According to an embodiment of the present invention, a method providing enhanced protection of an integrated circuit using logic locking operations in a computing environment, by one or more processors, in a computing system. A logic locking (finite-state machine) FSM component or a logic locking with register-transfer level RTL gating may be applied to a current design logic to enable and protect operations of an integrated circuit, where the current design logic remains unchanged. The operation of the integrated circuit may be activated based upon providing to the integrated circuit a correct key from the logic locking FSM component or the logic locking with RTL gating.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5 is a block diagram depicting an exemplary operations for providing a locking FSM module, where an enhanced protection of an integrated circuit in which aspects of the present invention may be realized.

FIG. 6 is a block diagram depicting an exemplary operations for using a built-in self-test (“BIST”) in which aspects of the present invention may be realized.

FIG. 7 is a block diagram depicting an exemplary operations for using a scan-chain in which aspects of the present invention may be realized.

FIG. 8A is a block diagram depicting an exemplary operations for RTL clock gating in which aspects of the present invention may be realized.

FIG. 8B is a block diagram depicting an exemplary operations for logic locking using RTL clock gating in which aspects of the present invention may be realized.

FIG. 9 is a flowchart diagram depicting an exemplary method for providing enhanced protection of an integrated circuit by a processor, again in which aspects of the present invention may be realized.

### DETAILED DESCRIPTION OF THE DRAWINGS

The present invention relates generally to the field of electrical, electronic, and computer arts, and more specifically, to semiconductor Electronic Design Automation (EDA) and the like.

An integrated circuit (IC) is an electronic circuit formed using a semiconductor material, such as Silicon, as a substrate and by adding impurities to form solid-state electronic devices, such as transistors, diodes, capacitors, and resistors. Commonly known as a “chip” or a “package”, an integrated circuit is generally encased in hard plastic, forming a “package”. Moreover, the IC chip may include a large number of electronic components that are fabricated by layering several different materials on a silicon base or wafer. The design of an IC transforms a circuit description into a geometric description which is known as a layout. A layout typically consists of a set of planar geometric shapes in several layers. A generated layout has to be checked to ensure that it meets all of the design requirements. The result of this check is a set of design files in a particular unambiguous representation known as an intermediate form that describes the layout. The design files are then converted into pattern generator files that are used to produce patterns called “masks” by an optical or electron beam pattern generator.

The process of converting the functional specifications of an electronic circuit into the layout is called the physical design. The objective of the physical design is to determine an optimal arrangement of devices in a plane or in a three-dimensional space, and an efficient interconnection or routing scheme between the devices to obtain the desired functionality. The physical design of a microelectronic IC commonly is an automated optimization process using digital computers and specialized Computer Aided Design (CAD) tools. Automation of the physical design process has increased the level of integration, reduced turn-around time and enhanced chip performance.

For the physical design of ICs, prefabricated elements are used that provide combinatorial or storage functions. These elements are called cells (or types). A collection of different cells forms a library. The usage of a cell in a design is referred to as instance or circuit. If most of cells have the same height and connect their power through abutted placement in circuit row, the cells are called standard cells and the design style standard cell layout. A particular design element of an IC is a so-called “pin” which refers to a physical or logical access terminal to a cell and circuit. An example for a pin is an inverter having one input and one output pin.

The mentioned instances of an IC are interconnected or routed in accordance with the logical design of the circuit to provide the desired functionality. Hereby the various elements of the circuit are interconnected by electrically conductive lines or traces that are routed through vertical channels and horizontal channels that run between the cells.

In addition, IC chips typically have several metal layers upon which the wires are routed with the horizontal wires routed on different layers than the vertical wires. An electrical connection between two nets on adjacent layers is implemented using a so-called “via” which is an etched hole in a substrate's oxide for allowing a conductive path to extend from one layer to another layer of the underlying IC chip, that can be used e.g., for conducting power (so-called “power via”) or even signals. The routing program must therefore produce a list of horizontal and vertical segments for each net, connected by the mentioned vias, all of which have to be conformal with the underlying technology requirements, also known as ‘ground rules’, for wire spacing and wire capacity.

Moreover, the IC chip is fabricated by first conceiving the logical circuit description, and then converting that logical description into the physical description, or the geometric layout. This process is usually carried out using a “netlist,” which is a record of all of the nets, or interconnections, between the cell pins. Every net is classified into one of four different categories: short nets, flat nets, L-shaped nets, and Z-shaped nets. A short net is a net that locates in one tile or bin. A flat net spans at most one tile in either the vertical or horizontal direction. An L-shaped net or a Z-shaped net spans more than one tile in either direction and have one or two bends, respectively. A short net is a two-pin net whose two gates are on adjacent rows and a horizontal distance is less than a given threshold (e.g., less than 5 placement tracks). For a multiple-pin net, if two pin connection is close (e.g., less than five placement tracks), the multiple-pin net can also be treated as a short net.

Challenges arise that effect a system on a chip (“SoC”) integrator/foundry by illegal and unauthorized access, use, and ownership of intellectual property (“IP”) without consent. An IP owners suffer financial and reputational losses and then it becomes difficult to detect under current IC manufacturing and supply chain. Also, logic locking is an operation to protect IP from unauthorized access, use, and ownership of intellectual property. The logic locking may be an operation wherein an additional next additional key logic—chip functions as expected only when correct key is loaded. However, problems arise relating to timing, area, and power overhead due to key-related logics.

Accordingly, the present invention provides a novel solution by providing enhanced protection of an integrated circuit using logic locking operations in a computing environment, by one or more processors, in a computing system. A logic locking FSM component or a logic locking with RTL gating may be applied to a current design logic to enable and protect operations of an integrated circuit, where the current design logic remains unchanged. The operation of the integrated circuit may be activated based upon providing to the integrated circuit a correct key from the logic locking FSM component or the logic locking with RTL gating. In one aspect, the present invention may employ an integer linear programming operation.

In some implementations, a light-weight logic locking operation using a locking FSM module. The locking FSM module is connected to an integrated circuit (“IC”) to be protected. The IC works and functions only when correct key is given. When key is incorrect, the IC is placed/force into a non-functional mode and isolate functional inputs

In other implementations, a leveraging RTL clock gating for logic locking may be executed. In one aspect, clock gating enable signal is modified so that the clock gating enable signal includes a secret key. A clock signal propagates to sequencing elements only when correct key is given. When key is incorrect, the clock signal is gated and so sequencing elements do not capture new logic value. An ILP (Integer Linear Programming) operation is used.

Also, as used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

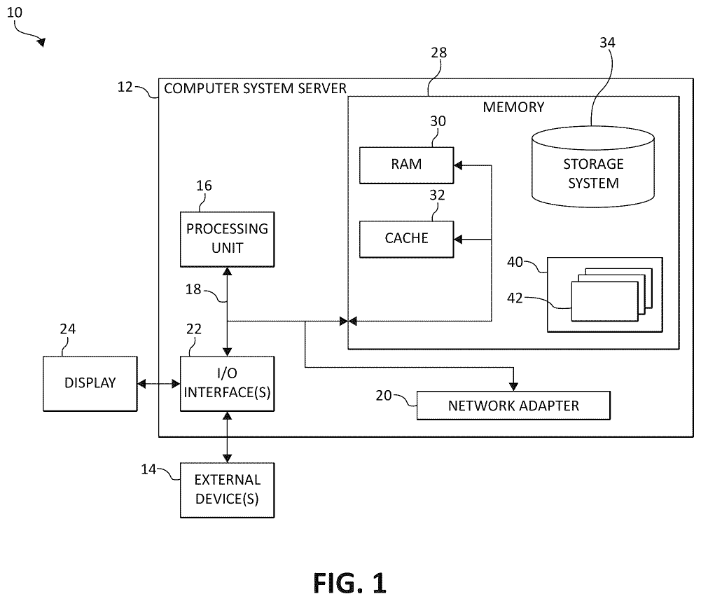

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

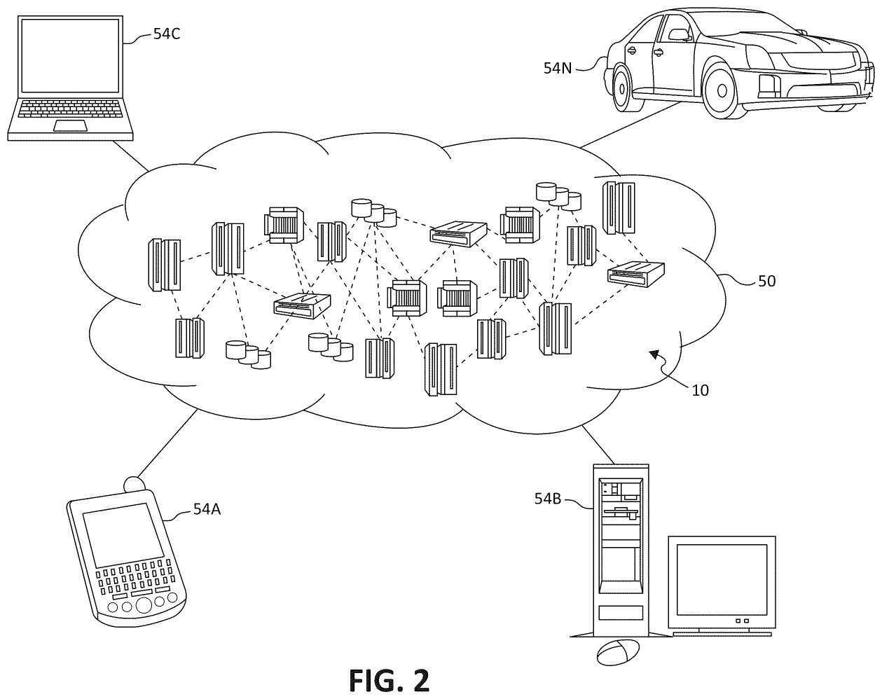

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

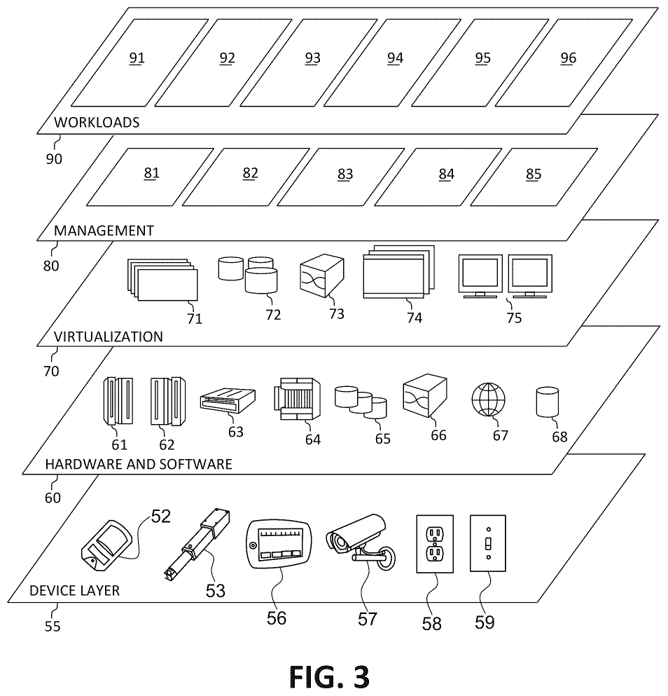

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 providing enhanced protection of an integrated circuit using logic locking operations in a computing environment (e.g., in a neural network architecture). In addition, workloads and functions 96 for providing enhanced protection of an integrated circuit using logic locking operations in a computing environment may include such operations as analytics, deep learning, and as will be further described, user and device management functions. One of ordinary skill in the art will appreciate that the workloads and functions 96 for providing enhanced protection of an integrated circuit using logic locking operations in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

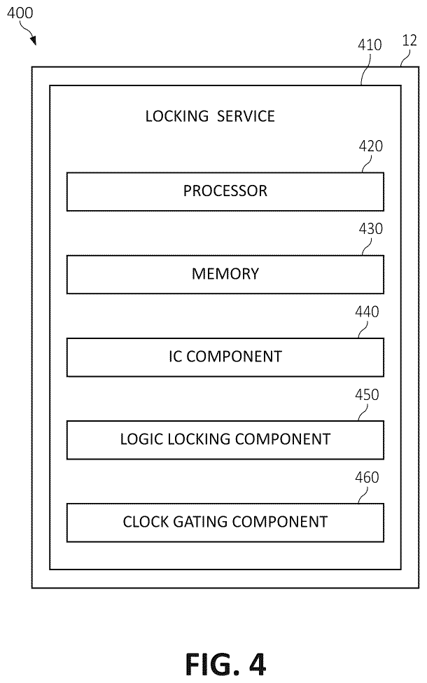

Turning now to FIG. 4, a block diagram depicting exemplary functional components of system 400 for providing enhanced protection of an integrated circuit using logic locking operations in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

In one aspect, the computer system/server may provide virtualized computing services (i.e., virtualized computing, virtualized storage, virtualized networking, etc.) to the intelligent conversational agent management and interaction service 402 and the conversation agent 404. More specifically, the computer system/server 12 may provide virtualized computing, virtualized storage, virtualized networking and other virtualized services that are executing on a hardware substrate.

A locking service 410 is shown, incorporating processing unit 420 (“processor”) to perform various computational, data processing and other functionality in accordance with various aspects of the present invention. In one aspect, the processor 420 and memory 430 may be internal and/or external to the locking service 410, and internal and/or external to the computing system/server 12. The locking service 410 may be included and/or external to the computer system/server 12, as described in FIG. 1. The processing unit 420 may be in communication with the memory 430. The locking service 410 may include an integrated circuit (“IC”) component 440, a logic locking component 450, and a clock gating component 460.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

In some implementation, the locking service 410, using the IC component 440, thee logic locking component 450, and/or the clock gating component 460, may automatically apply a logic locking FSM component.

In some implementation, the locking service 410, using the IC component 440, thee logic locking component 450, and/or the clock gating component 460, may automatically connect the logic locking FSM component to the current design logic. In some implementation, the locking service 410, using the IC component 440, thee logic locking component 450, and/or the clock gating component 460, may place the integrated circuit into a non-functional mode upon the receiving an incorrect key, wherein the operations are prevented from executing in the integrated circuit.

In some implementation, the locking service 410, using the IC component 440, thee logic locking component 450, and/or the clock gating component 460, may modify a clock gating enable signal to include a secret key as the correct key. In some implementation, the locking service 410, using the IC component 440, thee logic locking component 450, and/or the clock gating component 460, may propagate a clock signal to sequencing elements upon sending the correct key.

In some implementation, the locking service 410, using the IC component 440, thee logic locking component 450, and/or the clock gating component 460, may gate a clock signal to disable sequencing elements from capturing a new logic value by one or more based upon an incorrect key. In some implementation, the locking service 410, using the IC component 440, thee logic locking component 450, and/or the clock gating component 460, may automatically apply a logic locking FSM component or a logic locking with RTL gating to a current design logic at a gate level, at a resistor-transition logic level, or on an abstraction level.

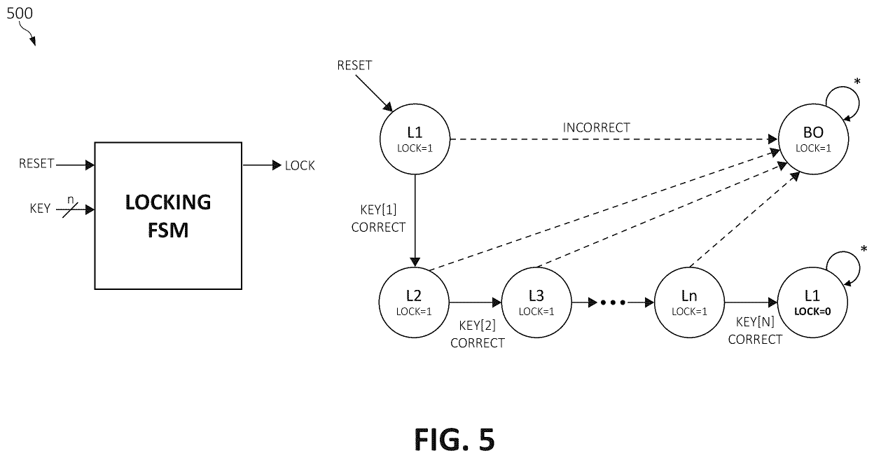

For further explanation, FIG. 5 is a block diagram 500 depicting an exemplary operations for providing a locking FSM module, where an enhanced protection of an integrated circuit in which aspects of the present invention may be realized. In one aspect, one or more of the components, modules, services, applications, and/or functions described in FIGS. 1-4 may be used in FIG. 5.

As depicted, an N-bit key may be provided to the locking FSM module. The locking FSM module produces, generates, and outputs a 1-bit lock signal. A states of the IC may be locked (L), unlocked (U) and black-hole (B). For example, when an IC executes a boot operation at an initial locked state, the locking FSM module may be locked at L1. A correct n-bit key sequence may be provided to reach an unlocked state. In the event that the wrong key arrived, there is a danger that the key will cause the FSM to go into infinite black hole loop.

Also, the locking FSM module can be automatically generated. Users can generate their own locking FSM module for a locking FSM generator. The locking FSM generator, receives as input, uses a user-specified N-bit key values. The Locking FSM may be provided in hardware-description language, e.g., Verilog/VHDL.

Thus, the FSM module may 1) create a blackhole and unlocked state, 2) create an N number of locked states {L1, . . . , LN}, 3) for i in {1, . . . , N−1}: 4) create arc Li to the blackhole using key[i], 5) create arc Li to Li+1 using key[i]; and 6) create arc LN to a blackhole using key[N], and 7) create arc LN to U using key[iN]. Thus, a user specified key of 101, for example, generates a locking FSM.

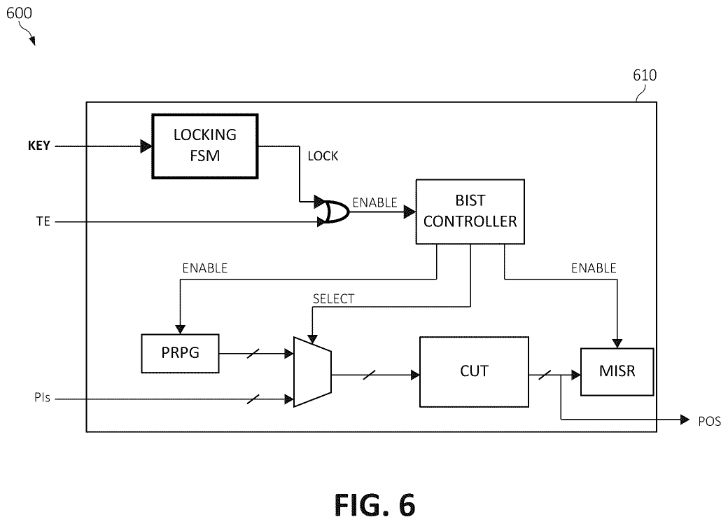

For further explanation, FIG. 6 is a block diagram 600 depicting an exemplary operations for using a built-in self-test (“BIST”) in which aspects of the present invention may be realized. In one aspect, one or more of the components, modules, services, applications, and/or functions described in FIGS. 1-5 may be used in FIG. 6.

In one aspect, the present invention may execute an application to use a Built-In Self-Test (BIST). In test mode (TE=1), Pis may be isolated from circuit (“CUT”). One or more patterns generated from a Pseudo-random Pattern Generator (“PRPG”) may enter the CUT. The CUT outputs may be stored in a Multiple Input Signature Registers (“MISR”) and produce test signatures. A locking FSM (e.g., a key) may be inserted in test-enable logic path and the test mode is always activated when incorrect key is given.

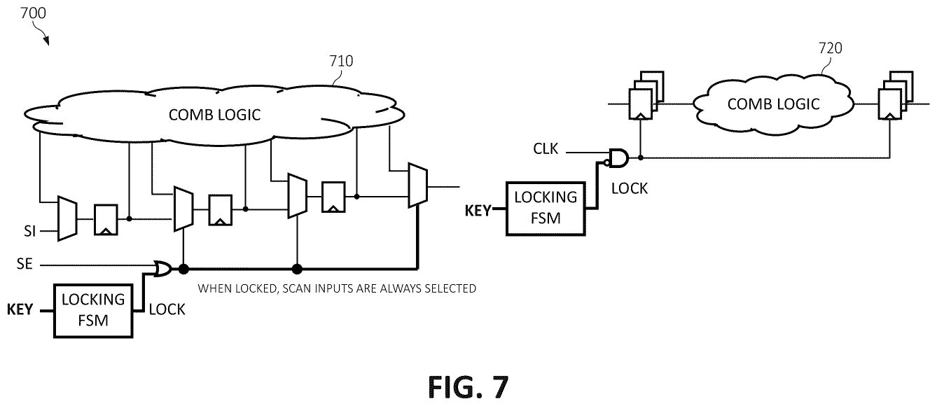

FIG. 7 is a block diagram 700 depicting an exemplary operations for using a scan-chain in which aspects of the present invention may be realized. In one aspect, one or more of the components, modules, services, applications, and/or functions described in FIGS. 1-6 may be used in FIG. 7.

In one aspect, the present invention may execute an application to use a scan-chain. In scan mode (SE=1), scan inputs (SI) are propagated to next latches. A locking FSM may be inserted in a scan-enable logic path. The scan mode is always activated when incorrect key is given/provided. When locked, scan inputs are always selected.

A clock enable key may be used. One or more sequencing elements do not capture data if aa clock signal is not provided. The locking FSM may be inserted in clock path. If the incorrect key is provided and/or received, a clock is shut off from sequencing element and the circuit does not function appropriately.

In this way, there are no delay overhead during functional operation, no additional logic in functional data paths pointing to the timing overhead, rea and power overhead: a) very small and the locking FSM is smaller compared to the IC to be protected 0.11% for a rocket chip core (e.g., conventional locking methods: area overhead up to 30%) and b) to integrate on any design given a secret key. The locking FSM is created automatically and includes Locking FSM in IC, a select control paths (e.g., test enable, scan logic, etc.), and connect a Locking FSM to the select control paths.

### Leveraging RTL Clock-Gating for Logic Locking

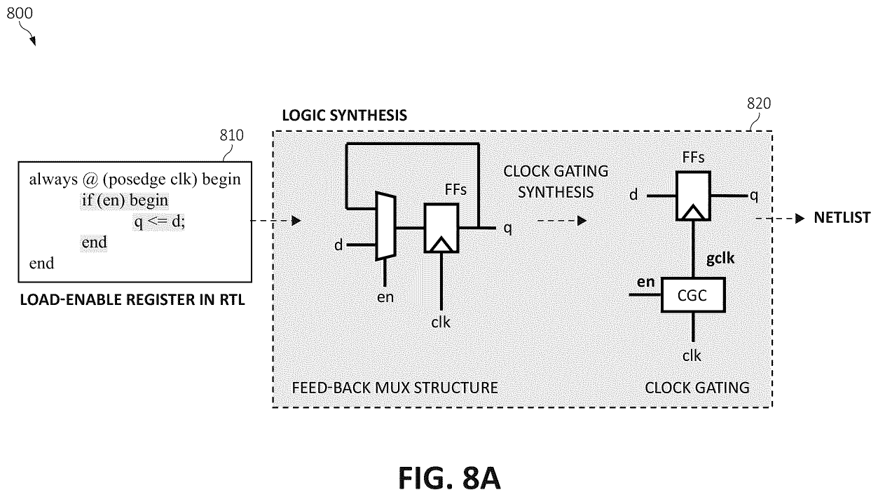

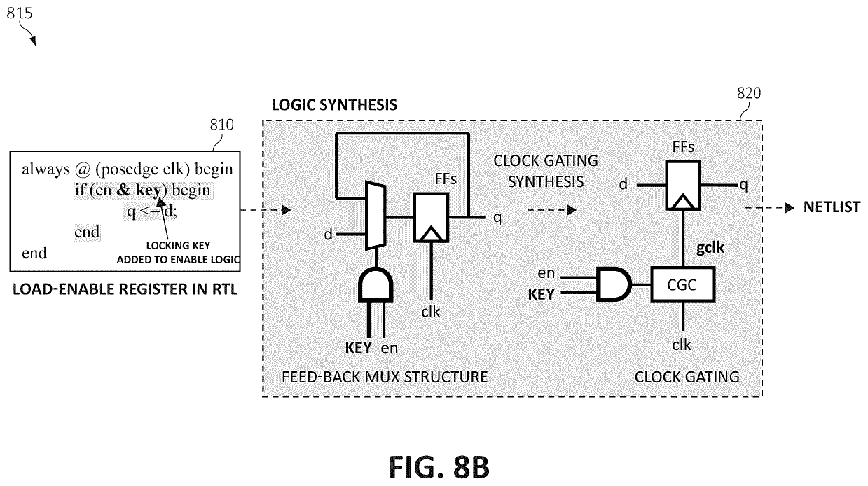

Turning now to FIG. 8A is a block diagram 800 depicting an exemplary operations for RTL clock gating in which aspects of the present invention may be realized. FIG. 8B is a block diagram depicting an exemplary operations for logic locking using RTL clock gating in which aspects of the present invention may be realized. In one aspect, one or more of the components, modules, services, applications, and/or functions described in FIGS. 1-7 may be used in FIGS. 8A-8B. In one aspect, one or more of the components, modules, services, applications, and/or functions described in FIGS. 1-6 may be used in FIG. 8A-8B.

For RTL Clock Gating, it should be noted that there are no explicit clock gating cell instance exists in RTL. A clock gating structure may synthesized from RTL (e.g., logic synthesis 810). One or more load-enable registers may be identified in the RTL and feed-back MUX structures may provide feedback. The feed-back MUX structures may transform into clock gating to provide a netlist.

Turning now to FIG. 8B, in some implementations, a logic locking operation using RTL clock gating (e.g., logic synthesis 820). A key signal may be added into an enable logic of load-enable register. For example, a correct key having a 0 value (e.g., correct key=0) and an AND gate have been provided with a key as inputs. When incorrect key (1) is given, the AND gate outputs 0. A clock to FF is then gated towards what FF does not capture new data, i.e., not working.

In one aspect, the present invention may be provided at the gate level, at a resistor-transition logic level, or on an abstraction level. In one aspect, the gate-level is similar to conventional logic locking methods of: 1) given RTL, a logic synthesis may be executed and a gate-level netlist may be received. A key signal on clock gating enable logic. Given RTL, an enable logic of load enable registers may be identified and one or more inject key signals on them. A higher abstraction level proposed method can be applied to higher-level abstraction that can generate RTL.

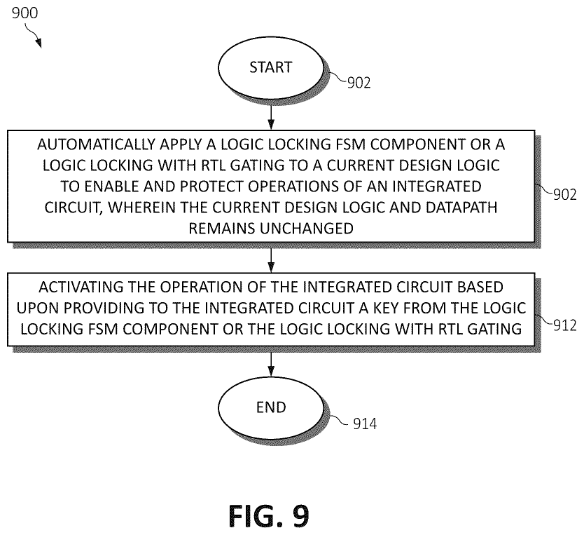

Turning now to FIG. 9, a method 900 for providing enhanced protection of an integrated circuit using a processor is depicted, in which various aspects of the illustrated embodiments may be implemented. The functionality 900 may be implemented as a method executed as instructions on a machine, where the instructions are included on at least one computer readable medium or one non-transitory machine-readable storage medium. The functionality 900 may start in block 902.

A logic locking FSM component or a logic locking with RTL gating may be applied to a current design logic to enable and protect operations of an integrated circuit, where the current design logic remains unchanged, as in block 904. The operation of the integrated circuit may be activated based upon providing to the integrated circuit a correct key from the logic locking FSM component or the logic locking with RTL gating, as in block 906. The functionality 900 may end, as in block 908.

In one aspect, in conjunction with and/or as part of at least one blocks of FIG. 9, the operation of method 900 may include each of the following. The operations of 900 may place the integrated circuit into a non-functional mode upon the receiving an incorrect key, wherein the operations are prevented from executing in the integrated circuit.

The operations of 900 may modify a clock gating enable signal to include a secret key as the correct key. The operations of 900 may propagate a clock signal to sequencing elements upon sending the correct key.

The operations of 900 may gate a clock signal to disable sequencing elements from capturing a new logic value by one or more based upon an incorrect key. The operations of 900 may automatically apply a logic locking FSM component or a logic locking with RTL gating to a current design logic at a gate level, at a resistor-transition logic level, or on an abstraction level.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing enhanced protection of an integrated circuit in a computing environment by one or more processors comprising:
automatically applying a logic locking FSM component or a logic locking with RTL gating to a current design logic to enable and protect operations of an integrated circuit, wherein the current design logic remains unchanged; and
activating the operation of the integrated circuit based upon providing to the integrated circuit a correct key from the logic locking FSM component or the logic locking with RTL gating.

2. The method of claim 1, further including automatically connecting the logic locking FSM component to the current design logic.

3. The method of claim 1, further including placing the integrated circuit into a non-functional mode upon the receiving an incorrect key, wherein the operations are prevented from executing in the integrated circuit.

4. The method of claim 1, further including modifying a clock gating enable signal to include a secret key as the correct key.

5. The method of claim 1, further including propagating a clock signal to sequencing elements upon sending the correct key.

6. The method of claim 1, further including gating a clock signal to disable sequencing elements from capturing a new logic value by one or more based upon an incorrect key.

7. The method of claim 1, further including automatically applying a logic locking FSM component or a logic locking with RTL gating to a current design logic at a gate level, at a resistor-transition logic level, or on an abstraction level.

8. A system for providing enhanced protection of an integrated circuit in a computing environment in a computing environment, comprising:
one or more computers with executable instructions that when executed cause the system to:
automatically apply a logic locking FSM component or a logic locking with RTL gating to a current design logic to enable and protect operations of an integrated circuit, wherein the current design logic remains unchanged; and
activate the operation of the integrated circuit based upon providing to the integrated circuit a correct key from the logic locking FSM component or the logic locking with RTL gating.

9. The system of claim 8, wherein the executable instructions when executed cause the system to automatically connect the logic locking FSM component to the current design logic.

10. The system of claim 8, wherein the executable instructions when executed cause the system to place the integrated circuit into a non-functional mode upon the receiving an incorrect key, wherein the operations are prevented from executing in the integrated circuit.

11. The system of claim 8, wherein the executable instructions when executed cause the system to modify a clock gating enable signal to include a secret key as the correct key.

12. The system of claim 8, wherein the executable instructions when executed cause the system to propagate a clock signal to sequencing elements upon sending the correct key.

13. The system of claim 8, wherein the executable instructions when executed cause the system to gate a clock signal to disable sequencing elements from capturing a new logic value by one or more based upon an incorrect key.

14. The system of claim 8, wherein the executable instructions when executed cause the system to automatically apply a logic locking FSM component or a logic locking with RTL gating to a current design logic at a gate level, at a resistor-transition logic level, or on an abstraction level.

15. A computer program product for providing enhanced protection of an integrated circuit in a computing environment in a computing environment, the computer program product comprising:
one or more computer readable storage media, and program instructions collectively stored on the one or more computer readable storage media, the program instruction comprising:
program instructions to automatically apply a logic locking FSM component or a logic locking with RTL gating to a current design logic to enable and protect operations of an integrated circuit, wherein the current design logic remains unchanged; and
program instructions to activate the operation of the integrated circuit based upon providing to the integrated circuit a correct key from the logic locking FSM component or the logic locking with RTL gating.

16. The computer program product of claim 15, further including program instructions to automatically connect the logic locking FSM component to the current design logic.

17. The computer program product of claim 15, further including program instructions to place the integrated circuit into a non-functional mode upon the receiving an incorrect key, wherein the operations are prevented from executing in the integrated circuit.

18. The computer program product of claim 15, further including program instructions to modify a clock gating enable signal to include a secret key as the correct key.

19. The computer program product of claim 15, further including program instructions to:
propagate a clock signal to sequencing elements upon sending the correct key; and
gate a clock signal to disable sequencing elements from capturing a new logic value by one or more based upon an incorrect key.

20. The computer program product of claim 15, further including program instructions to automatically apply a logic locking FSM component or a logic locking with RTL gating to a current design logic at a gate level, at a resistor-transition logic level, or on an abstraction level.
